(19) United States
(12) Patent Application Publication
(10) Pub. No.: US 2019/0156400 A1
(43) Pub. Date: May 23, 2019

(54) ELECTRONIC SYSTEM AND METHOD FOR GIFTS PURCHASE

(71) Applicant: MASTERCARD INTERNATIONAL INCORPORATED, Purchase, NY (US)

(72) Inventors: Deepti DHAPOLA, Pune (IN); Rupesh SATPUTE, Pune (IN)

(21) Appl. No.: 16/186,910

(22) Filed: Nov. 12, 2018

(30) Foreign Application Priority Data
Nov. 17, 2017 (SG) 10201709514Y

(51) Int. Cl. G06Q 30/06; G06Q 20/12

(52) U.S. Cl. CPC G06Q 30/0635; G06Q 30/0609; G06Q 20/12

(57) ABSTRACT

A system comprises a merchant server, the merchant server configured for performing steps of a method, comprising: receiving, from an electronic device of the sender, a distributed dataset comprising details of the recipients identified by the sender to receive the gifts and price brackets for the gifts determined by the sender, each recipient associated with a price bracket; generating a number of gift selection addresses based on the distributed dataset, each gift selection address associated with a recipient and linking to a merchant interface accessible by an electronic device of the recipient; communicating the gift selection addresses to the recipients; and receiving, from the electronic devices of the recipients and via the merchant interface, selections of gifts selected by the recipients from merchandise of the merchant according to the respective price brackets, wherein the gifts selected by the recipients are payable to the merchant by a payment instrument of the sender.

### TECHNICAL FIELD

The present disclosure generally relates to an electronic system and method for gifts purchase. More particularly, the present disclosure describes various embodiments of an electronic system and method for performing gifts purchase transactions and for purchasing gifts from a merchant by a sender for a number of recipients.

### BACKGROUND

There are many occasions when someone purchases a gift for another person or gifts for other people. It is easier when purchasing a gift for one person as the gift can be more personalized. However, for bigger festivities and celebrations such as weddings, it becomes difficult to personalize the gifts due to the large number of guests. For weddings, it is often customary to provide gifts or souvenirs for your guests. The gifts are usually pre-selected beforehand by the hosts, i.e. groom and bride, from a small number of standardized products. For example, the hosts would select the same gift to be distributed to all the guests, or in some cases, select two or three different gifts to be evenly distributed among the guests. As the guests generally receive the same gift(s), some guests may feel that the hosts are not being thoughtful enough, especially so for a once-in-a-lifetime wedding occasion.

Moreover, the guests include family members of the hosts and the hosts may want to provide them with special gifts, instead of the same standard gift as with the other guests. For example, the hosts may allocate a higher budget for the gifts to the family members, and a lower budget for the other guests. Within the family members, the budget for a close relative may be more relaxed than for a distant cousin. There are multiple responsibilities for the hosts during preparation of wedding. Having to think about different gifts for each guest and buying thoughtful gifts for them would only add responsibility to and burden the hosts.

Therefore, in order to address or alleviate at least one of the aforementioned problems and/or disadvantages, there is a need to provide an electronic system and method for gifts purchase, in which there is at least one improved feature.

### BRIEF SUMMARY

According to a first aspect of the present disclosure, there is an electronic system, a computerized method, and a non-transitory computer-readable storage medium for performing gifts purchase transactions, the gifts purchasable from a merchant by a sender for a number of recipients. The system comprises a server of the merchant, the merchant server configured for performing steps of the method, comprising: receiving, from an electronic device of the sender, a distributed dataset comprising details of the recipients identified by the sender to receive the gifts and price brackets for the gifts determined by the sender, each recipient associated with a price bracket; generating a number of gift selection addresses based on the distributed dataset, each gift selection address associated with a recipient and linking to a merchant interface accessible by an electronic device of the recipient; communicating the gift selection addresses to the recipients; and receiving, from the electronic devices of the recipients and via the merchant interface, selections of gifts selected by the recipients from merchandise of the merchant according to the respective price brackets, wherein the gifts selected by the recipients are payable to the merchant by a payment instrument of the sender.

According to a second aspect of the present disclosure, there is an electronic system, a computerized method, and a non-transitory computer-readable storage medium for purchasing gifts from a merchant by a sender for a number of recipients. The system comprises an electronic device of the sender, the sender electronic device configured for performing steps of the method, comprising: generating a recipient dataset comprising details of the recipients identified by the sender to receive the gifts; generating a number of price datasets, each price dataset associated with a price bracket for the gifts determined by the sender; distributing the recipient dataset and price datasets among each other, such that each recipient is associated with a price bracket; generating a distributed dataset comprising details of the recipients and the price brackets associated therewith; and communicating the distributed dataset to a server of the merchant for generating a number of gift selection addresses based on the distributed dataset, each gift selection address associated with a recipient, wherein the gift selection addresses are communicable to the respective recipients, each gift selection address linking to a merchant interface accessible by an electronic device of the respective recipient to select a gift from merchandise of the merchant according to the respective price bracket; and wherein the gifts selected by the recipients are payable to the merchant by a payment instrument of the sender.

An electronic system and method for gifts purchase according to the present disclosure is thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is an illustration of an electronic system for performing gifts purchase transactions, in accordance with embodiments of the present disclosure.

FIG. 2 is a flowchart illustration of a computerized method implemented on a merchant server of the electronic system of FIG. 1 for performing gifts purchase transactions, in accordance with embodiments of the present disclosure.

FIG. 3 is a flowchart illustration of a computerized method implemented on a sender electronic device of the electronic system of FIG. 1 for performing gifts purchase transactions, in accordance with embodiments of the present disclosure.

FIG. 4 is a flowchart illustration of a computerized method implemented on a recipient electronic device of the electronic system of FIG. 1 for performing gifts purchase transactions, in accordance with embodiments of the present disclosure.

FIG. 5 illustrates various examples of distributed datasets of the gifts purchase transactions, in accordance with embodiments of the present disclosure.

FIG. 6 is a block diagram illustration of the technical architecture of a merchant server of the electronic system of FIG. 1, in accordance with embodiments of the present disclosure.

### DETAILED DESCRIPTION

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “/” in a figure or associated text is understood to mean “and/or” unless otherwise indicated. For purposes of brevity and clarity, descriptions of embodiments of the present disclosure are directed to an electronic system and method for gifts purchase, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, known systems, methods, procedures, and components have not been described in detail so as to not unnecessarily obscure aspects of the embodiments of the present disclosure.

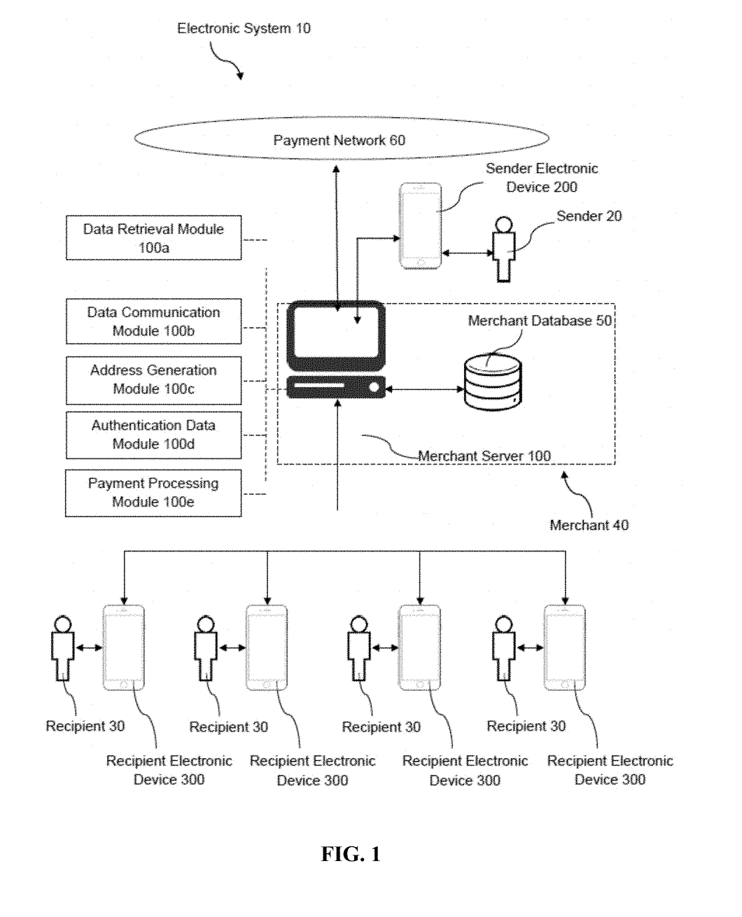

In representative or exemplary embodiments of the present disclosure, there is provided an electronic system 10 for performing gifts purchase transactions as illustrated in a schematic diagram in FIG. 1. The system 10 includes a server 100 having a processor and a data storage device or memory configured to store computer-readable instructions. The gifts are purchasable by a sender 20 for a number of recipients 30 and from a merchant 40. The server 100 is operated by the merchant 40 for performing the gifts purchase transactions, and may also be referred to as the merchant server 100. As shown in FIG. 1, the merchant server 100 includes various modules/components 100a-e for performing various functions/steps in the gifts purchase transactions, as will be described further in this description.

The system 10 further includes a number of electronic devices 200 and 300. The sender 20 holds and operates an electronic device 200 (also referred to as sender electronic device 200). Similarly, each recipient 30 holds and operates an electronic device 300. Each electronic device 200/300 is communicable with the server 100 for performing the gifts purchase transactions.

The sender 20 begins the gifts purchase by browsing through merchandise offered by the merchant 40. Details of the merchandise may be retrieved by the merchant server 100 from a merchant database 50 and communicated to the sender electronic device 200. The sender electronic device 200 generates a recipient dataset comprising details of the recipients 30 identified by the sender 20 to receive the gifts. The sender electronic device 200 further generates a number of price datasets, each price dataset associated with a price bracket for the gifts determined by the sender 20. The recipient dataset and price datasets are distributed among each other, such that each recipient 30 is associated with a price bracket. The sender electronic device 200 then generates a distributed dataset comprising details of the recipients 30 and the price brackets associated therewith. For example, the distributed dataset includes data associating a particular recipient 30 with a particular price bracket, wherein the gift which the sender is intending to give to said recipient has to be within said price bracket.

The sender electronic device 200 communicates the distributed dataset to the merchant server 100. The merchant server 100 generates a number of gift selection addresses, e.g. uniform resource locators (URLs), based on the distributed dataset. Each gift selection address is associated with a recipient 30, or in other words is unique to the recipient 30. The merchant server 100 communicates the gift selection addresses to the respective recipients 30.

For each recipient 30, the gift selection addresses links to a merchant interface, such as an interface that is part of the online platform of the merchant 40, accessible by the recipient electronic device 300. A recipient 30 uses the recipient electronic device 300 to access the merchant interface via gift selection address. The recipient 30 browses for gifts via the merchant interface and selects a gift from merchandise of the merchant 40 according to the price bracket associated with said recipient 30. The recipient electronic device 300 communicates the selection of gift to the merchant server 100.

Accordingly, the recipients 30 access the merchant interface to select gifts from merchandise of the merchant 40 according to the respective price brackets. The gifts selected by the recipients 30 are payable to the merchant 40 by a payment instrument 202 of the sender 20. The system 10 includes a payment network 60 communicatively linked to the merchant server 100 for receiving details of the payment instrument 202 and processing payment to the merchant 40.

With this system 10, the sender 20 is able to allocate budgets for different recipients 30 in the form of the price brackets. For example, a recipient 30 who is a close family member may have a higher price bracket, e.g. $100 to $150, while another recipient 30 who is a distant cousin may have a lower price bracket, e.g. $50 to $100. Other recipients 30 who are casual friends of the sender 20 may have an even lower price bracket, e.g. $20 to $40. The system 10 allows the recipients 30 to choose and select gifts from merchandise of the merchant 40 according to the price brackets. Advantageously, each recipient 30 can select his/her desired gift, at least one that is within the associated price bracket, and the sender 20 can more easily plan an overall budget based on the price brackets for all the recipients 30.

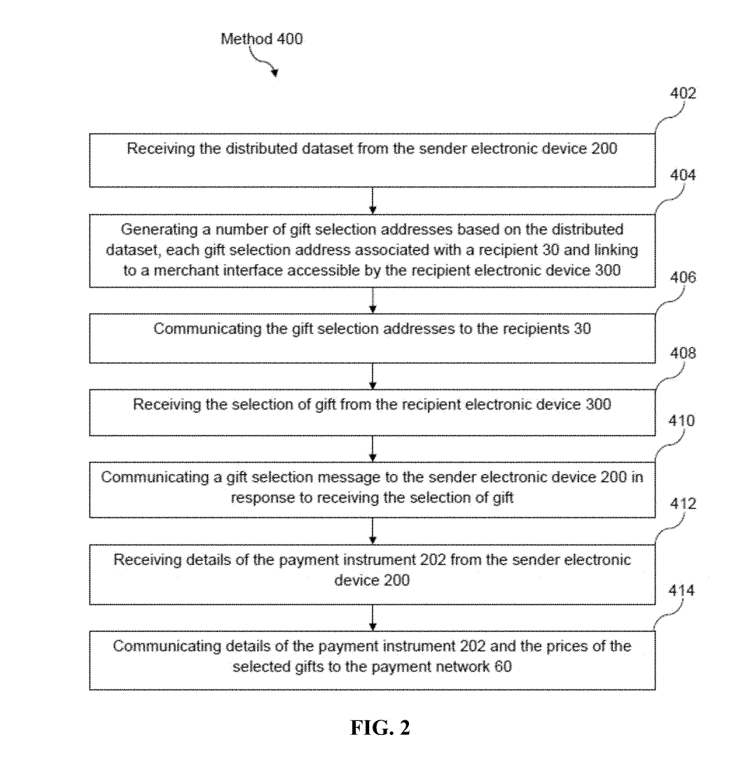

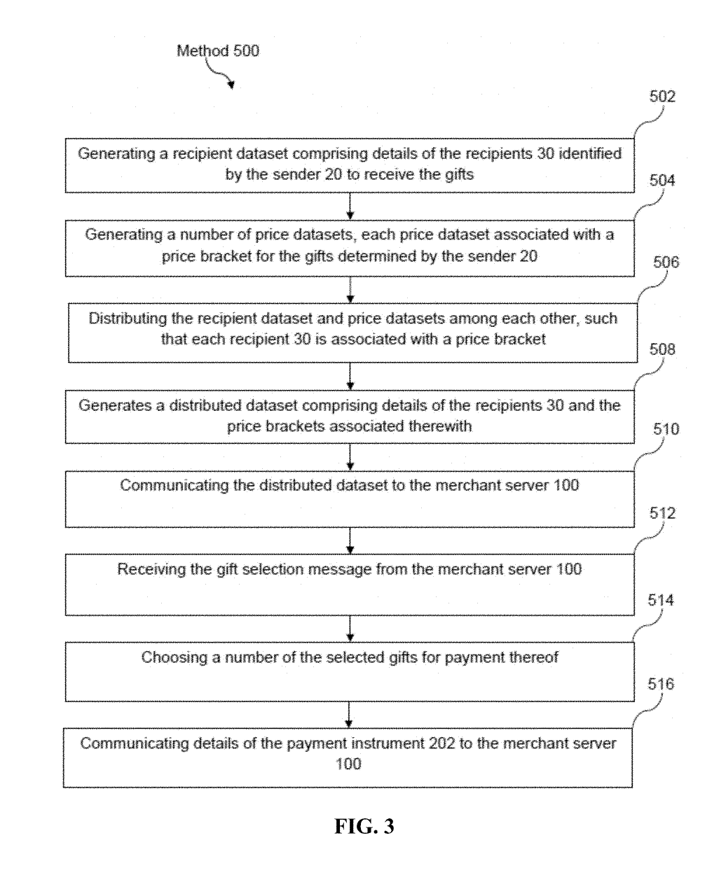

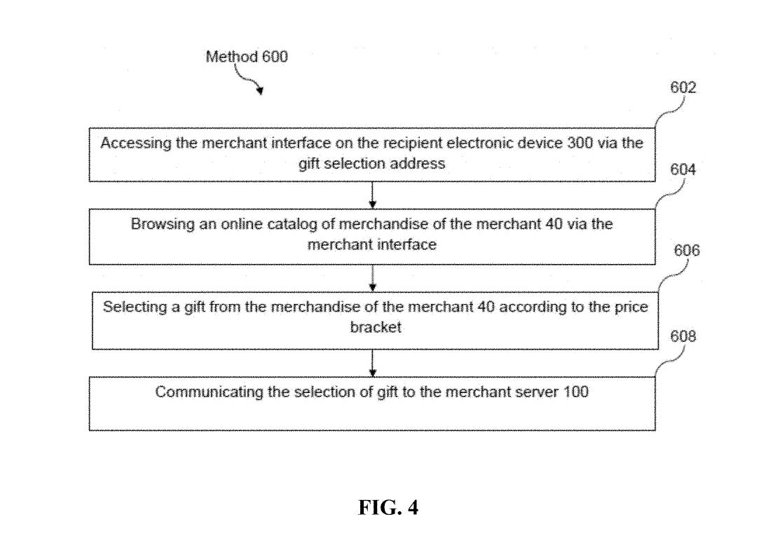

In various embodiments further with reference to FIG. 2 to FIG. 4, there is shown various computer-implemented or computerized methods 400, 500, and 600 implemented on the electronic system 10 for performing gifts purchase transactions. FIG. 2 shows a computer-implemented or computerized method 400 implemented on the merchant server 100; FIG. 3 shows a corresponding computer-implemented or computerized method 500 implemented on the sender electronic device 200, and FIG. 4 shows a corresponding computer-implemented or computerized method 600 implemented on one recipient electronic device 300. Each electronic device 200/300 may be a mobile device such as a mobile phone, smartphone, personal digital assistant (PDA), tablets, laptop, or computer.

Using the sender electronic device 200, the sender 20 begins the purchasing of gifts for the recipients 30 from the merchant 40, such as Amazon® or Walmart®. In one embodiment, the sender 20 executes a web browser application on the sender electronic device 200 to access an online website or platform hosted by the merchant 40 on the merchant server 100 and browses an online catalog of merchandise. In another embodiment, the merchant 40 provides a software application which the sender 20 has pre-installed on the sender electronic device 200. The sender 20 executes the application on the sender electronic device 200 and browses the online catalog within the application. Details of the merchandise on the online catalog may be retrieved from the merchant database 50 by a data retrieval module/component 100a of the merchant server 100 and communicated to the sender electronic device 200. As used herein, a gift is defined as a merchandise item, e.g. good, product, or service, sold or offered for sale by the merchant 40 and is purchased by the sender 20 and given freely to a recipient 30.

The sender 20 firstly identifies the recipients 30 whom he/she is purchasing the gifts for. Particularly, the sender 20 uses the sender electronic device 200 to generate a list of the recipients 30. In a step 502 of the method 500, the sender electronic device 200 generates a recipient dataset comprising details of the recipients 30 identified by the sender 20 to receive the gifts. The recipient dataset may be in the form of a list or matrix structure that is readable by the sender 20 to verify the information of the recipients 30. The recipient dataset may include various details associated with each recipient, such as but not limited to, name, home address, email address, phone number, and relationship to sender 20, etc. In one embodiment, the sender electronic device 200 has an existing contacts database stored therein or retrievable from a remote computer cloud system. The recipient dataset may be generated by importing the contacts database into the online platform or application of the merchant 40. In another embodiment, the sender 20 manually enters details of one or more of the recipients 30, especially those who are not already on any existing contacts database.

After identifying the recipients 30, the sender 20 proceeds to create various budgets of the gifts he/she would be purchasing. Specifically, the sender 20 determines various price brackets for the gifts. For example, some gifts may have a bigger price bracket while other gifts may have a smaller price bracket. A price bracket may be defined as a price range, e.g. from $100 to $150, or may alternatively be defined as a price point, e.g. approximately $100.

Furthermore, if the sender 20 is intending to purchase the gifts with some loyalty/reward points, e.g. accrued from the merchant 40 or on a payment instrument 202 of the sender 20, the price bracket may be indicated in the form of the loyalty/reward points in addition or alternatively to the monetary values. In a step 504, the sender electronic device 200 generates a number of price datasets, each price dataset associated with a price bracket for the gifts determined by the sender 20.

In some embodiments, the sender 20 further determines a number of merchandise categories for the gifts he/she is purchasing for the recipients 30. This would be beneficial in terms of shipping logistics as the sender 20 can prevent the recipients 30 from selecting bulky items even though they may satisfy the price bracket.

In a step 506, the sender 20 distributes the recipient dataset and price datasets among each other, such that each recipient 30 is associated with a price bracket. In one embodiment, the distribution includes allocating/assigning each recipient 30 to one price dataset. Alternatively, the distribution includes allocating/assigning each price dataset to one or more recipients 30. Each recipient 30 is allocated/assigned thus associated with a specific price bracket which represents the price range or price point of the gift the sender 20 is purchasing for the recipient 30. As described above, recipients 30 who are closer to the sender 20, e.g. immediate family members and long-time friends, may be allocated/assigned with a higher price bracket, e.g. $200, while more distant recipients 30, e.g. ex-colleagues, may be allocated/assigned with a lower price bracket, e.g. $30.

In some embodiments, in addition to each recipient 30 being associated with a price bracket, a group of recipients 30 may be associated with an aggregated price cap. For example, each recipient 30 in a group of ten recipients 30 may have a price bracket of $20 to $50, and the group of ten recipients 30 may have aggregated price cap of $400. Notably, the aggregated price cap is lower than the maximum possible price if each recipient 30 goes for the upper end of the price bracket. This may be helpful to the sender 20 to avoid a situation whereby every recipient 30 selects gifts at the upper end of the price bracket, potentially exceeding the sender's budget.

In some embodiments, the sender 20 further distributes the merchandise categories among the recipients 30, such that each recipient 30 is associated with one or more merchandise categories. For example, the sender 20 may know that a recipient 30 recently has a newborn baby, and may allocate/assign the recipient 30 to the merchandise category of baby products. In another example, the sender 20 may know that a recipient 30 has recently moved into a new house, and may allocate/assign the recipient to the merchandise categories of electronics, kitchen appliances, and furniture.

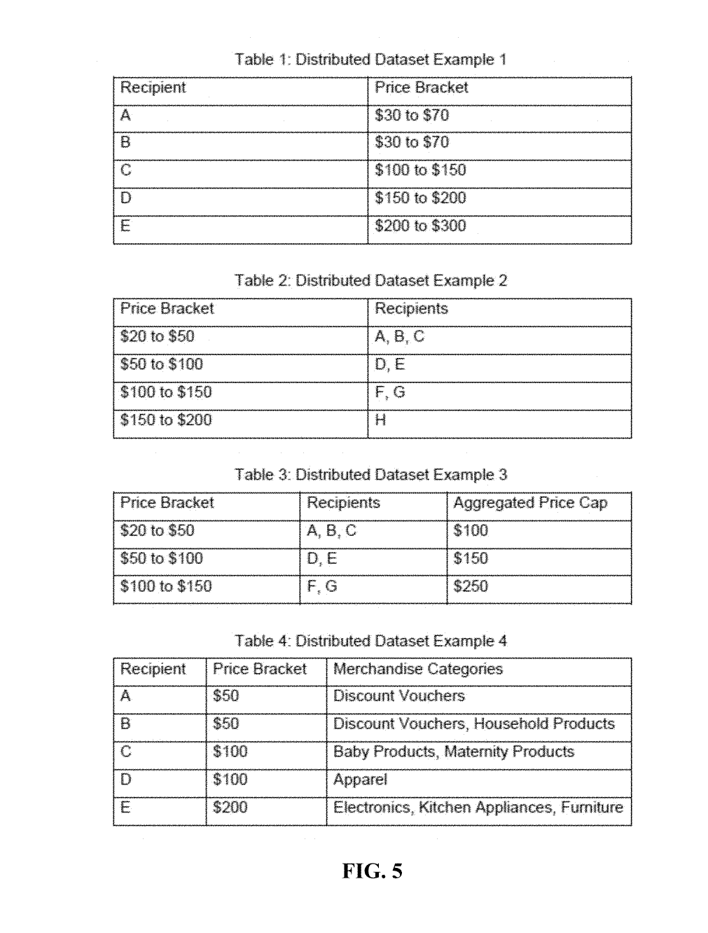

In a step 508, the sender electronic device 200 generates a distributed dataset comprising details of the recipients 30 and the price brackets associated therewith, and optionally of the merchandise categories. Table 1 to Table 4 in FIG. 5 illustrate various examples of the distributed dataset represented in a matrix format.

In a step 510, the sender electronic device 200 communicates the distributed dataset to the merchant server 100. Correspondingly, in a step 402 of the method 400, the merchant server 100 receives the distributed dataset from the sender electronic device 200. Communications between the merchant server 100 and the sender electronic device 200 occur between a data communication module/component 100b of the merchant server 100 and a data communication module/component of the sender electronic device 200.

In a step 404, an address generation module/component 100c of the merchant server 100 generates a number of gift selection addresses based on the distributed dataset, each gift selection address associated with a recipient 30 and linking to a merchant interface accessible by the recipient electronic device 300. Each gift selection address may be represented by a uniform resource locator/identifier (URL/URI) or two-dimensional matrix barcode (QR code) that is readable by the recipient electronic device 300. It will be appreciated that the merchant interface is hosted by the merchant 40 on the merchant server 100 and may be part of or connected to the online platform or software application of the merchant 40.

In some embodiments, an authentication data module/component 100d of the merchant server 100 generates authentication data for the recipients 30 to access the merchant interface, wherein the authentication data is unique to each gift selection address. Specifically, each recipient 30 has a unique gift selection address and a corresponding authentication data.

The recipient 30 is required to enter the authentication data when he/she accesses the merchant interface via the gift selection address. The authentication data may be a random password or personal identification number (PIN).

In a step 406, the merchant server 100 communicates the gift selection addresses to the recipients 30. The details of the recipients 30 in the distributed dataset may include an email address and/or phone number of each recipient 30. The gift selection addresses may be communicated via email to the email addresses of the recipients 30, and/or via text message to the phone numbers of the recipients 30. In some embodiments, the merchant server 100 also communicates the authentication data to the recipients 30. Particularly, the authentication data is communicated separately from the gift selection address. For example, the authentication data is communicated in separate emails and/or text messages to the recipients 30.

In one embodiment, the merchant server 100 communicates the gift selection addresses and the authentication data via email and/or text message to the recipients 30. In another embodiment, the merchant server 100 communicates the gift selection addresses and authentication data to the sender electronic device 200, and the sender 20 then shares them with the recipients 30. The sender 20 may additionally share a personalized message to the recipients 30 together with the communication of the gift selection addresses and authentication data.

For each recipient 30, after receiving the gift selection address, the recipient 30 reads the gift selection address with the recipient electronic device 300. In a step 602 of the method 600, the recipient 30 accesses the merchant interface on the recipient electronic device 300 via the gift selection address and with the authentication data if required. In one embodiment, the recipient 30 executes a web browser to access the merchant interface via the gift selection address, which may be an URL. In another embodiment, the gift selection address is represented as a QR code and the recipient electronic device 300 reads the QR code to access the merchant interface. In another embodiment, the merchant 40 provides a software application which the recipient 30 has pre-installed on the recipient electronic device 300. The recipient 30 executes the application on the recipient electronic device 300 to access the merchant interface via the gift selection address.

In a step 604, the recipient 30 uses the recipient electronic device 300 to browse an online catalog of merchandise of the merchant 40 via the merchant interface. Details of the merchandise on the online catalog may be retrieved from the merchant database 50 by the data retrieval module/component 100a of the merchant server 100 and communicated to the recipient electronic device 300. Each merchandise product availed to the recipient 30 may be assigned a unique product identifier, such as a product identification code and/or a QR code. Communications between the merchant server 100 and the recipient electronic device 300 occur between the data communication module/component 100b of the merchant server 100 and a data communication module/component of the recipient electronic device 300.

As the recipient 30 is associated with a price bracket for the gift, details of the merchandise communicated to the recipient electronic device 300 is limited to those within the associated price bracket. The price bracket may be hidden from the recipient 30 so that he/she does not know the budget the sender 20 has allocated to him/her. In addition, if the sender 20 has limited the recipient 30 to certain merchandise categories for the gift, details of the merchandise are further limited to these merchandise categories.

In a step 606, after browsing the merchandise details, the recipient 30 selects a gift from the merchandise of the merchant 40 according to the price bracket and optionally the merchandise category. In one embodiment, the recipient 30 selects the gift by clicking on the particular merchandise product displayed in the online catalog, after which the selected gift is added to a shopping cart of the sender 20. In another embodiment, the recipient 30 uses another electronic device 300, e.g. a mobile phone, to input the product identification code of the particular merchandise product and communicate the product identification code by SMS text messaging to a short code, which is known by or informed to the recipient 30. In another embodiment, the recipient 30 may use the mobile phone to scan the QR code of the particular merchandise product to select it as the gift.

In some embodiments, the merchant interface provides a field for the recipient 30 to input a delivery address. In other embodiments, this field is omitted and the recipient 30 is not allowed to input a delivery address. This may be decided by the sender 20 so that all the selected gifts of all the recipients 30 can be delivered to a common delivery address determined by the sender 20, such as a wedding venue. This may be beneficial if the sender 20 prefers to hand the selected gifts in person to the respective recipients 30.

Optionally, the recipient 30 may be part of a group of recipients 30 that is associated with an aggregated price cap kept hidden from each recipient 30 of the group. To illustrate this, each recipient 30 in a group of ten recipients 30 may be associated with a price bracket of $20 to $50, and the group of ten recipients may be associated with an aggregated price cap of $400. When a first recipient 30 selects a gift that costs $50, the aggregated price cap may be adjusted according to predefined algorithms. For example, the aggregated price cap may be adjusted to $360 for the remaining nine recipients 30. Alternatively or additionally, the price bracket associated with each of the remaining nine recipients 30 may be adjusted according to predefined algorithms, such as to $20 to $45. The merchandise details shown to the remaining nine recipients 30 for browsing and selection of gifts will be revised according to the adjusted price brackets and/or aggregated price caps. Potentially, after nine recipients 30 in the group have respectively selected their gifts, the last recipient 30 may potentially find himself/herself having to select a gift within an adjusted price bracket of, for example, $20 to $30 and/or within an adjusted aggregated price cap of, for example, $30.

In a step 608, the recipient electronic device 300 communicates the selection of gift and optionally the delivery address to the merchant server 100. Correspondingly, in a step 408 of the method 400, the merchant server 100 receives the selection of gift and optionally the delivery address from the recipient electronic device 300. In a subsequent step 410, the merchant server 100 communicates a gift selection message to the sender electronic device 200 in response to receiving the selection of gift and optionally the delivery addresses. Correspondingly, in a step 512 of the method 500, the sender electronic device 200 receives the gift selection message from the merchant server 100. This gift selection message informs the sender 20 that the recipient 30 has selected a gift and the sender 20 may proceed with payment of the selected gift. The selected gift is added to the shopping cart of the sender 20 which the sender 20 may access via the online platform/website/application of the merchant 40. Optionally, the gift selection message includes an address, e.g. URL, which links to the shopping cart.

Accordingly, each recipient 30 that has received the gift selection addresses performs the method 600 to select a gift from the merchandise availed to him/her. Each gift selection address may expire after a predefined period, e.g. 7 days. The recipient 30 is thus required to make the gift selection within this predefined period, otherwise he/she would lose the opportunity to do so. This predefined period may be determined by the sender 20/merchant 40 so that the sender 20 does not need to wait indefinitely for all the recipients 30 to select their gifts. This is particularly beneficial if the sender 20 has a certain deadline to meet, e.g. a wedding date. The gift selection address may also automatically expire after the recipient 30 has selected the gift, so as to prevent misuse of the same gift selection address.

After receiving a number of the gift selection messages, the sender 20 may proceed to pay for the selections of gifts of the recipients 30. Each selection of gift may expire after a predefined period, e.g. 7 days. The sender 20 is thus required to pay for the selected gift within this predefined period. This predefined period may be determined by the merchant 40 so that the selected gift does not remain indefinitely in the shopping cart.

In one embodiment, the selected gifts of the recipients 30 are collectively payable by the payment instrument 202 in one transaction, i.e. all the selected gifts in the shopping cart are paid in a single transaction. In another embodiment, the selected gifts of the recipients 30 are payable by the payment instrument 202 in separate transactions, i.e. each transaction is associated with one recipient 30 and is for the selected gift of the recipient 30.

In another embodiment, a plurality of the selected gifts are chosen by the sender 20 and are collectively payable by the payment instrument 202 in one transaction. In yet another embodiment, the sender 20 may have pre-authorized payment of some gifts for certain recipients 30, e.g. family members. When these recipients 30 select their gifts, the gifts are automatically paid for without requiring the sender 20 to perform a subsequent transaction.

In a step 514 of the method 500, the sender 20 uses the sender electronic device 200 to choose a number of the selected gifts for payment thereof. Additionally, the sender 20 may input a delivery address for delivering the selected gifts. The delivery address may be determined by the sender 20 if the recipients 30 are not allowed to do so or if the sender 20 decides to supersede the delivery addresses provided by the recipients 30.

At a payment gateway or checkout page of the online platform/website/application, the sender 20 inputs details of the payment instrument 202 for payment of the selected gifts. The payment instrument 202 may be any suitable cashless payment mode or mechanism, such as payment cards. Payment cards may include credit cards, debit cards, prepaid cards, and/or charge cards which the customer uses to pay for transactions. In addition to payment cards, payment instruments may include, but are not limited to, membership cards, promotional cards, frequent flyer cards, identification cards, gift cards, and/or any other payment cards that may hold payment card information and which may be stored electronically.

In one embodiment, the sender 20 manually inputs details of the payment instrument 202, e.g. credit card number, expiry date, and security code, with the sender electronic device 200. In another embodiment, the sender electronic device 200 is configured and operative as a digital wallet linked to at least the payment instrument 202. The digital wallet may be operated on a software application executable on the sender electronic device 200. An example of a digital wallet is Masterpass® by Mastercard®. Details of the payment instrument 202 may be tokenized and stored locally on the sender electronic device 200, or retrieved remotely with the sender electronic device 200. The digital wallet may be integrated with the application of the merchant 40 so as to seamlessly provide details of the payment instrument 202.

In a step 516, the sender electronic device 200 communicates details of the payment instrument 202 to the merchant server 100. Correspondingly, in a step 412 of the method 400, the merchant server 100 receives the details of the payment instrument 202 from the sender electronic device 200. In a subsequent step 414, a payment processing module/component 100e of the merchant server 100 communicates the details of the payment instrument 202, together with the prices of the selected gifts, to the payment network 60 for processing payment of the transactions. The payment network 60 may be a system network for settling financial transactions. The payment network 60 may be operated by an organization such as a payment card or credit card association, e.g. Mastercard® or Visa®. The payment network 60 connects or links together multiple financial institutions, particularly issuer banks and acquirer banks for processing payment of the transactions between merchants and customers, e.g. the sender 20. The processing of payment by the payment network 60, including communications between the acquirer bank and issuer bank, is performed in a standard manner and will be readily understood by the skilled person.

It will be appreciated that in addition or alternative to paying for the selected gifts monetarily with the payment instrument 202, the selected gifts may be paid with loyalty of reward points accrued from the merchant 40 or on the payment instrument 202. It will also be appreciated that by paying for the selected gifts, the sender 20 may accrue loyalty/reward points from the merchant 40 or on the payment instrument 202.

As described in the methods 400, 500, and 600, the recipients 30 are able to select their own gifts from the merchandise of the merchant 40 according to the price brackets and optionally the merchandise categories determined by the sender 20. Advantageously, each recipient 30 can select his/her desired gift that would be within the price bracket which is the budget allocated by the sender 20. By allocating the budget for each recipient 30, the sender 20 can plan a collective budget for all the gifts and purchase them for the recipients 30 after they have selected their preferred gifts. Further advantageously, the recipients 30 would not receive the same standard gift as the others and likely be able to select a gift that he/she wants. The sender 20 would not need to spend time thinking about what gift to purchase for each recipient 30 as the decision is passed to the recipient 30. This saves time for the sender 20 which he/she can utilize on more crucial matters, such as planning of the occasion, e.g. wedding, which the recipients 30 have been invited to attend.

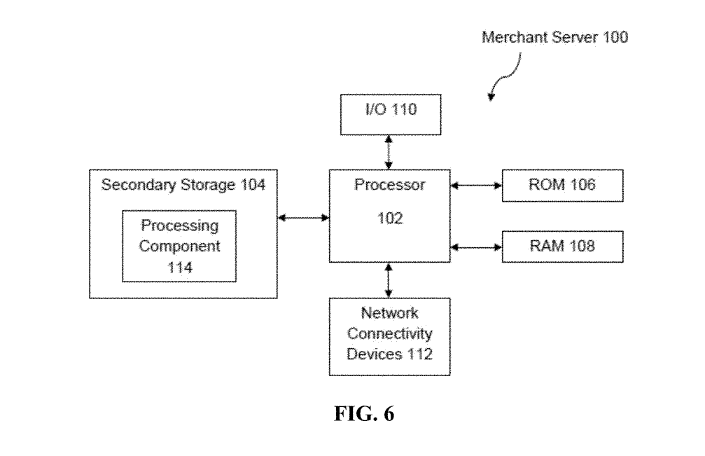

The following is a description of the technical architecture of the merchant server 100 with reference to FIG. 6. It will be appreciated that the electronic device 200/300 may have a similar technical architecture as well.

The technical architecture of the server 100 includes a processor 102 (also referred to as a central processor unit or CPU) that is in communication with memory devices including secondary storage 104 (such as disk drives or memory cards), read only memory (ROM) 106, and random access memory (RAM) 108. The processor 102 may be implemented as one or more CPU chips. Various modules or components for performing various operations or steps of the methods 400, 500, and 600 are configured as part of the processor 102 and such operations or steps are performed in response to non-transitory instructions operative or executed by the processor 102.

The technical architecture further includes input/output (I/O) devices 110, and network connectivity devices 112. The secondary storage 104 typically includes a memory card or other storage device and is used for non-volatile storage of data and as an over-flow data storage device if RAM 108 is not large enough to hold all working data. Secondary storage 104 may be used to store programs which are loaded into RAM 108 when such programs are selected for execution.

The secondary storage 104 has a processing component 114, including non-transitory instructions operative by the processor 102 to perform various operations or steps of the methods 400, 500, and 600 according to various embodiments of the present disclosure. The ROM 106 is used to store instructions and perhaps data which are read during program execution. The secondary storage 104, the ROM 106, and/or the RAM 108 may be referred to in some contexts as computer-readable storage media and/or non-transitory computer-readable media. Non-transitory computer-readable media include all computer-readable media, with the sole exception being a transitory propagating signal per se.

The I/O devices 110 may include printers, video monitors, liquid crystal displays (LCDs), plasma displays, touch screen displays, keyboards, keypads, switches, dials, mice, track balls, voice recognizers, card readers, paper tape readers, and/or other known input devices.

The network connectivity devices 112 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communication (NFC), radio frequency identity (RFID), and/or other air interface protocol radio transceiver cards, and other known network devices. These network connectivity devices 112 may enable the processor 102 to communicate with the Internet or one or more intranets. With such a network connection, it is contemplated that the processor 102 might receive information from the network, or might output information to the network in the course of performing the operations or steps of the methods 400, 500, and 600. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk-based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors.

It will be appreciated that the technical architecture of the server 100 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third-party provider.

It is understood that by programming and/or loading executable instructions onto the technical architecture of the server 100, at least one of the CPU 102, the ROM 106, and the RAM 108 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by known design rules.

In the foregoing detailed description, embodiments of the present disclosure in relation to an electronic system and method for gifts purchase are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

What is claimed is:

1. An electronic system for performing gifts purchase transactions, the gifts purchasable from a merchant by a sender for a number of recipients, the system comprising a merchant server, the merchant server configured for performing steps comprising:
receiving, from an electronic device of the sender, a distributed dataset comprising details of the recipients identified by the sender to receive the gifts and price brackets for the gifts determined by the sender, each recipient associated with a price bracket;
generating a number of gift selection addresses based on the distributed dataset, each gift selection address associated with a recipient and linking to a merchant interface accessible by an electronic device of the recipient;
communicating the gift selection addresses to the recipients; and
receiving, from the electronic devices of the recipients and via the merchant interface, selections of gifts selected by the recipients from merchandise of the merchant according to the respective price brackets,
wherein the gifts selected by the recipients are payable to the merchant by a payment instrument of the sender.

2. The system according to claim 1, wherein the selected gifts are (i) collectively payable by the payment instrument in one transaction, or (ii) payable by the payment instrument in separate transactions, each transaction associated with one recipient.

3. The system according to claim 2, the steps further comprising communicating, to a payment network, details of the payment instrument and prices of the selected gifts for processing payment of the one transaction or separate transactions.

4. The system according to claim 1, the steps further comprising generating authentication data for the recipients to access the merchant interface, wherein the authentication data is unique to each gift selection address.

5. The system according to claim 4, the steps further comprising communicating the authentication data to the recipients separately from the gift selection addresses.

6. The system according to claim 1, the steps further comprising communicating, to the electronic devices of the recipients, details of the gifts for selection thereof by the recipients.

7. The system according to claim 1, the steps further comprising communicating gift selection messages to the sender electronic device in response to receiving the selections of gifts.

8. The system according to claim 1, the steps further comprising receiving, from the electronic devices of the recipients and via the merchant interface, a delivery address for each recipient.

9. The system according to claim 1, wherein each gift selection address is represented by a uniform resource locator (URL) or matrix barcode.

10. The system according to claim 1, wherein each gift selection address expires after a predefined period.

11. The system according to claim 1, wherein each selection of gifts expires after a predefined period.

12. A computerized method for performing gifts purchase transactions, the gifts purchasable from a merchant by a sender for a number of recipients, the method performed by a merchant server and comprising:
receiving, from an electronic device of the sender, a distributed dataset comprising details of the recipients identified by the sender to receive the gifts and price brackets for the gifts determined by the sender, each recipient associated with a price bracket;
generating a number of gift selection addresses based on the distributed dataset, each gift selection address associated with a recipient and linking to a merchant interface accessible by an electronic device of the recipient;
communicating the gift selection addresses to the recipients; and
receiving, from the electronic devices of the recipients and via the merchant interface, selections of gifts selected by the recipients from merchandise of the merchant according to the respective price brackets,
wherein the gifts selected by the recipients are payable to the merchant by a payment instrument of the sender.

13. A non-transitory computer-readable storage medium storing computer-readable instructions that, when executed, cause the merchant server to perform steps of the method according to claim 12.

14. An electronic system for purchasing gifts from a merchant by a sender for a number of recipients, the system comprising an electronic device of the sender, the sender electronic device configured for performing steps comprising:
generating a recipient dataset comprising details of the recipients identified by the sender to receive the gifts;
generating a number of price datasets, each price dataset associated with a price bracket for the gifts determined by the sender;
distributing the recipient dataset and price datasets among each other, such that each recipient is associated with a price bracket;
generating a distributed dataset comprising details of the recipients and the price brackets associated therewith; and
communicating the distributed dataset to a server of the merchant for generating a number of gift selection addresses based on the distributed dataset, each gift selection address associated with a recipient,
wherein the gift selection addresses are communicable to the respective recipients, each gift selection address linking to a merchant interface accessible by an electronic device of the respective recipient to select a gift from merchandise of the merchant according to the respective price bracket; and
wherein the gifts selected by the recipients are payable to the merchant by a payment instrument of the sender.

15. The system according to claim 14, wherein in the distributed dataset, each recipient is further associated with one or more merchandise categories determined by the sender, and wherein the gifts are selected by each recipient according to the respective price bracket and merchandise categories.

16. The system according to claim 14, wherein in the distributed dataset, a group of recipients is associated with an aggregated price cap determined by the sender, and wherein the gifts are selected by each recipient in the group according to the respective price bracket and aggregated price cap.

17. The system according to claim 14, the steps further comprising communicating, to the merchant server, a delivery address input by the sender.

18. The system according to claim 14, wherein the details of each recipient comprise at least one of an email address and a phone number.

19. A computerized method for purchasing gifts from a merchant by a sender for a number of recipients, the method performed by the sender electronic device of the electronic system according to claim 14.

20. A non-transitory computer-readable storage medium storing computer-readable instructions that, when executed, cause the sender electronic device to perform steps of the method according to claim 19.
